(19) United States
(12) Patent Application Publication
(10) Pub. No.: US 2009/0011809 A1
(43) Pub. Date: Jan. 8, 2009

(54) Virtual Creature Character Fostering Apparatus

(75) Inventor: Yukiko Onuki, Tokyo (JP)

Correspondence Address: RANKIN, HILL & CLARK LLP, 38210 Glenn Avenue, WILLOUGHBY, OH, 44094-7808, US

(73) Assignee: KONAMI DIGITAL ENTERTAINMENT CO., LTD., Tokyo (JP)

(21) Appl. No.: 12/162,848

(22) PCT Filed: Jan. 31, 2007
(86) PCT No.: PCT/JP2007/051634

§ 371 Date: Jul. 31, 2008

(30) Foreign Application Priority Data
Feb. 1, 2006 (JP) 2006-025030

(51) Int. Cl. G06F 17/00

(52) U.S. Cl. 463/7

(57) ABSTRACT

A virtual creature character fostering apparatus, which allows a user to feel that the user is really involved in birth of a virtual creature character, is provided. The virtual creature character fostering apparatus includes a temperature sensor 13 disposed inside a casing 1 to detect a temperature of the casing 1, character-to-be-fostered selecting means 21, and display control means 23. The character-to-be-fostered selecting means 21 calculates an accumulated time length during which the temperature of the casing 1 detected by the temperature sensor 13 is equal to or higher than a predetermined temperature above ordinary temperature. Then, one or more virtual creature characters to be selected are determined among a plurality of kinds of virtual creature characters in accordance with the accumulated time length. The display control means 23 reads out an initial image of the selected virtual creature character from image storing means 25, and displays the image on an image display portion 4.

### TECHNICAL FIELD

The present invention relates to a virtual creature character fostering apparatus capable of displaying growing stages of a virtual creature character which is being fostered.

### BACKGROUND OF THE INVENTION

Japanese Patent Application Publication No. 07-160853 (JP07-160853A; Patent Document 1) discloses an image display device which detects ambient conditions with a temperature sensor and an illumination sensor, fosters a virtual creature using outputs from the temperature and illumination sensors as growth element data for the virtual creature, and displays a growing image thereof on an image display portion.

Japanese Patent Application Publication No. 2000-16948 (JP2000-116948; Patent Document 2) discloses an electronic apparatus which creates an unexpected virtual creature according to ambient conditions determined by outputs from an optical sensor and a temperature sensor, and displays an image of the virtual creature on an image display portion so that the virtual creature may be used in a game.

Further, Japanese Patent Application Publication No. 10-232595 (JP10-232595A; Patent Document 3) shows an example of a concrete configuration of a simulation apparatus which simulates a growing process of a virtual creature.

### DISCLOSURE OF THE INVENTION

### Problems to be Solved by the Invention

Conventionally-proposed simulation apparatuses which simulate the fostering process of a virtual creature character use outputs from a temperature sensor as conditions for growth or birth of the virtual creature character. In the conventional apparatuses, however, the outputs from the temperature sensor are merely used for detecting an ambient condition at a particular point of time. For this reason, the conventional apparatuses allow a user to experience a bird's behavior of warming an egg to let a chick be hatched, but the user cannot experience the process of fostering the virtual creature character. As a result, with such conventional devices, the user cannot feel as if the user is participating in the process of giving birth to the virtual creature character.

Accordingly, it is an object of the present invention to provide a virtual creature character fostering apparatus that allows a user to feel as if the user is participating in the process of giving birth to a virtual creature character.

Another object of the present invention is to provide a virtual creature character fostering apparatus that allows the user to look forward to checking birth conditions for the virtual creature character.

### Means of Solving the Problems

The virtual creature character fostering apparatus of the present invention includes a temperature sensor disposed inside a casing to detect a temperature of the casing, character-to-be-fostered selecting means, and display control means. The character-to-be-fostered selecting means outputs a selection command to select one or more virtual creature characters to be fostered among a plurality of kinds of virtual creature characters, based on an output from the temperature sensor. Specifically, the character-to-be-fostered selecting means calculates a time period during which the temperature of the casing detected by the temperature sensor is equal to or higher than a predetermined temperature above ordinary temperature (accumulated time length during which the temperature is equal to or higher than the predetermined temperature). Then, it determines the one or more virtual creature characters to be fostered among the plurality of kinds of virtual creature characters in accordance with the calculated time period (accumulated time length during which the temperature is equal to or higher than the predetermined temperature). More specifically, the predetermined temperature is a temperature above ordinary temperature and is defined based on the temperature of the casing when the casing is warmed by the body temperature of a human being. The display control means displays on an image display portion an initial image of the one or more virtual creature characters selected by the character-to-be-fostered selecting means among the plurality of kinds of virtual creature characters while the one or more virtual creature characters are growing up. The image display portion may be fixed to the casing.

When the one or more virtual creature characters to be fostered are determined in this manner, the user may feel that it is necessary for giving birth to the virtual creature character to warm the casing as with when a bird warms an egg to let a chick be hatched from the egg. According to the present invention, since different virtual creature characters are born depending on how long to warm (namely, the accumulated time length during which the casing is being warmed), the user may experience fostering of an unexpected virtual creature character by contriving the way of warming.

The configuration of the display control means is arbitrary. For example, it may be configured so that an initial image of the one or more virtual creature characters may be displayed on the image display portion based on the selection command, an output from the temperature sensor may be used as one of growth element data for promoting the growth of the one or more virtual creature characters selected by the character-to-be-fostered selecting means, and a growing image of the one or more virtual creature characters to be displayed on the image display portion may be determined based on the growth element data and displayed on the image display portion. With such configuration, since it is important to warm the casing even after the virtual creature character is born, the user may understand the importance of physical contact as with when the user brings up a real living creature.

Here, the accumulated time length as of the birth, during which the temperature of the casing is equal to or higher than the predetermined temperature above ordinary temperature, may be defined as a time period during which the temperature sensor is continuously detecting a temperature which is equal to or higher than the predetermined temperature. In this manner, a desired virtual creature character may not be born if the warming is interrupted. The user may accordingly understand that it is important for the birth to keep warming for a given period. When the accumulated time length is defined as a summation of time periods during which the temperature sensor is detecting a temperature which is equal to or higher than the predetermined temperature, even if user who is not familiar with how to warm gives up warming on the way, the user may still give birth to a new or unexpected virtual creature character. As a result, the user will not lose interest in the apparatus.

The character-to-be-fostered selecting means may be configured to include a determination command input means which inputs a determination command, and to select the one or more virtual creature characters to be fostered among the plurality kinds of virtual creature characters in accordance with an accumulated time length after the temperature of the casing detected by the temperature sensor has become a predetermined temperature till the determination command is input. In this manner, once the temperature of the casing has become the predetermined temperature, the accumulated time length is determined according to the timing at which the determination command is inputted. As a result, a virtual creature character may be born even when the warming behavior is not appropriate. Accordingly, even young children can use the apparatus.

The configuration of the image display portion is arbitrary. For example, the image display portion may include a display device disposed inside the casing and a view window portion disposed in the casing to allow the display device inside the casing to be viewed therethrough. A magnifying lens may be fit into the view window portion to enlarge the inside view. In such configuration, the user cannot grasp the current state and growing process at the first glance of the casing. To know the current state and growing process, the user has to look into the casing through the view window portion. That allows the user to feel as if the user was observing hatching of a living creature under a microscope and so on, and to feel as if the virtual creature character was really living therein, thereby arousing the user's interest.

Preferably, the temperature sensor may be installed inside the casing with a sensor portion thereof being in contact with an inner wall surface of the casing. In this manner, a change in the temperature of the casing may be detected directly, thereby improving responsiveness.

### BRIEF DESCRIPTION OF THE DRAWINGS

FIGS. 1A to 1C are a perspective view, a front view, and a right side view of an external appearance of a virtual creature character fostering apparatus according to one embodiment of the present invention.

FIGS. 2A and 2B are a vertical sectional view and a perspective view, in which a casing is partially omitted to show the inside, of the embodiment of FIG. 1.

FIG. 3 shows a typical screen of a display device.

FIG. 4 illustrates an example where the casing is forcibly warmed.

FIG. 5 is a block diagram showing a configuration of a main part of a control circuit mounted on a circuit substrate.

FIGS. 6A shows an image displayed on the screen before a virtual creature character is born, and FIG. 6B shows initial images of a plurality of virtual creature characters.

FIG. 7 shows gradual growing stages from birth to maturity of the plurality of virtual creature characters.

FIG. 8 is a flowchart showing a part of programming algorithm applied in implementing character-to-be-fostered selecting means using a microcomputer.

FIG. 9 is a flowchart showing a part of programming algorithm applied in implementing character-to-be-fostered selecting means using a microcomputer.

FIG. 10 is a flowchart schematically showing a basic operational algorithm in a fostering process.

FIG. 11 is a flowchart showing an example algorithm when a second temperature-condition determination means is used.

FIG. 12 is a flowchart schematically showing a basic algorithm of another embodiment of the present invention.

### BEST MODE FOR CARRYING OUT THE INVENTION

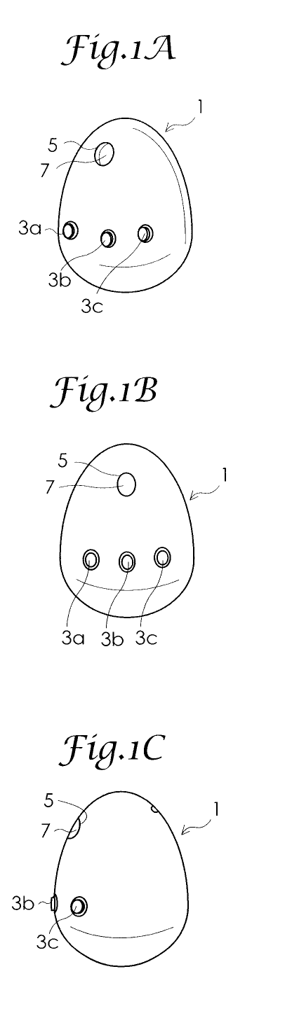

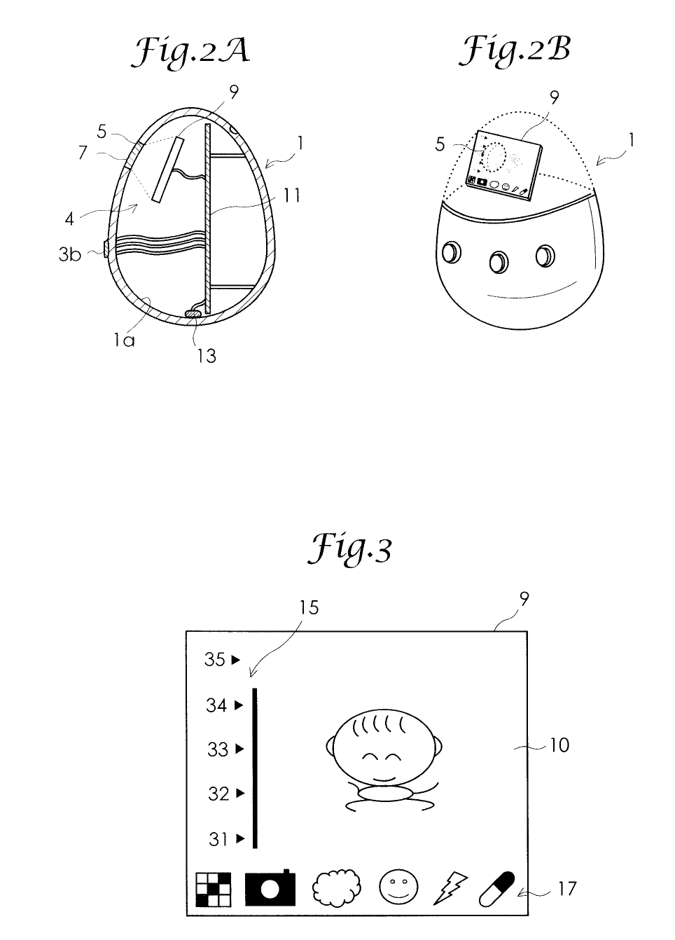

The best mode for carrying out the invention will now be hereinafter described in detail with reference to the accompanying drawings. FIGS. 1A to 1C are a perspective view, a front view, and a right side view of an external appearance of a virtual creature character fostering apparatus according to one embodiment of the present invention. FIGS. 2A and 2B are a vertical sectional view and a perspective view, in which a casing is partially omitted to show the inside, of the embodiment of FIG. 1. The apparatus includes an egg-shaped casing 1. Though not shown, the casing 1 is formed by combining a pair of casing half-portions, each of which is a vertically-cut half-portion of the casing. Three operation switches 3a to 3c are arranged on a lower portion of the casing 1. The operation switches 3a to 3c work as an electric power switch, a command input switch, and an icon selection switch, etc. A view window portion 5 is arranged on an upper portion of the casing 1. A magnifying lens 7 is fit into the view window portion 5 to enlarge the inside view. Inside the casing 1, a display device 9, which is constituted from a liquid crystal panel or the like, is disposed in a location which can be seen through the magnifying lens 7 of the view window portion 5. In the present embodiment, an image display portion 4 is constituted from the view window portion 5, the magnifying lens 7, and the display device 9. Although not shown, the display device 9 is fixed to the casing 1 via a circuit substrate 11. The type of the magnifying lens 7 and setting angle of the display device 9 are determined so that the screen of the display device 9 can be fully viewed when the user looks into the casing 1 through the view window portion 5 with one eye, as shown in FIG. 3.

Although not shown, a power supply circuit which uses a battery as a power source, a display device drive circuit, a control circuit including a microcomputer as arithmetic processing means, and other parts are mounted on the circuit substrate 11. A temperature sensor 13, for example a thermistor, is installed inside the casing 1 with a sensor portion thereof being in direct contact with an inner wall surface la of the casing 1. The temperature sensor 13 is attached onto the inner wall surface of a bottom region of the egg-shaped casing 1. Outputs from the temperature sensor 13 are processed by a control circuit, not shown, mounted on the circuit substrate 11.

In the present embodiment, as shown in FIG. 3 as one example of a display screen 10 of the display device 9, the display device 9 always displays on the display screen a temperature indicator 15 which indicates a temperature of the casing 1 detected by the temperature sensor 13 and an icon display portion 17 which displays six icons selected by any one of the operation switches 3a and 3b. The temperature indicator 15 is configured to show the temperature detected by the temperature sensor 13 in a bar graph. An image displayed in the center of FIG. 3 is a selected virtual creature character as explained later.

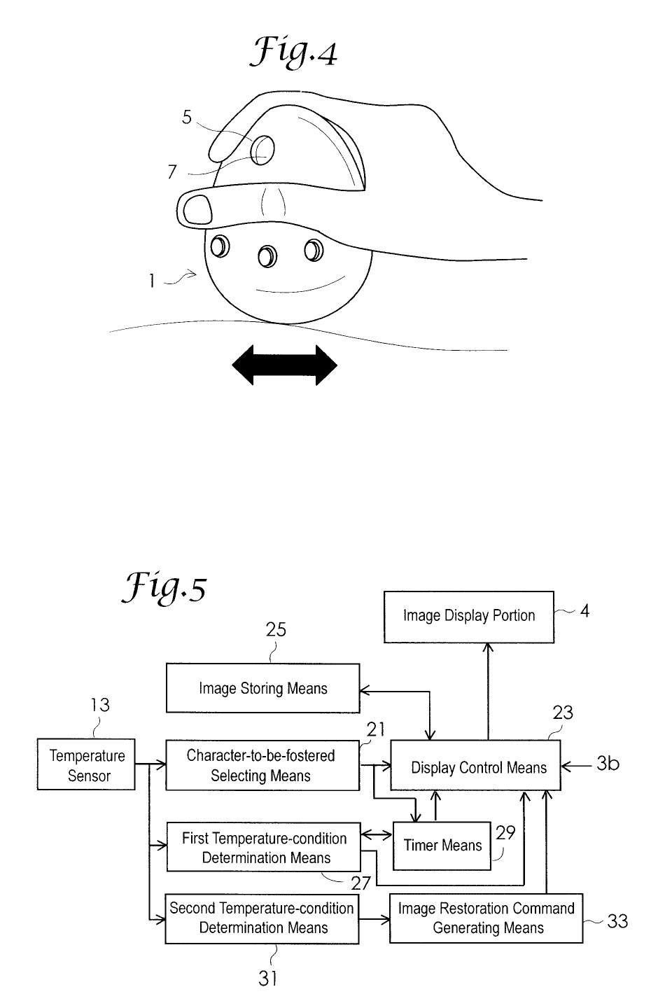

To operate the virtual creature character fostering apparatus, the user may warm the casing 1 by wrapping it with hands or keeping it in contact with the skin of a human being. Alternatively, the casing 1 may forcibly be warmed by rubbing a bottom portion of the casing 1 on the arm or thigh of a human being via clothes, as shown in FIG. 4. Above all, to increase the temperature of the casing 1 in a short time, it is the most effective to rub the casing against something as shown in FIG. 4.

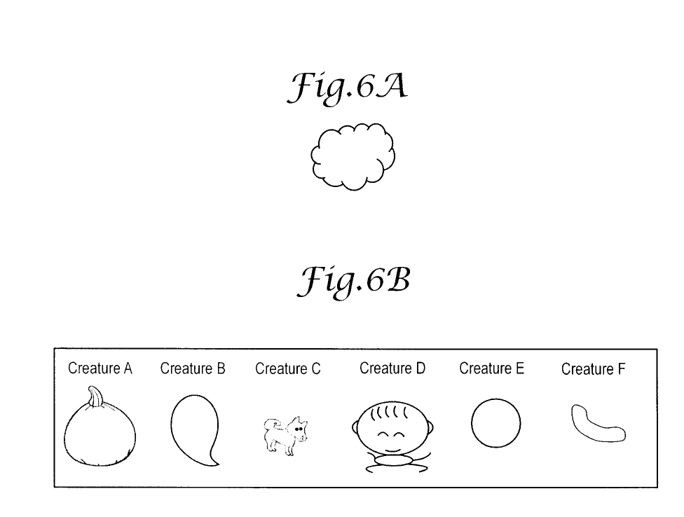

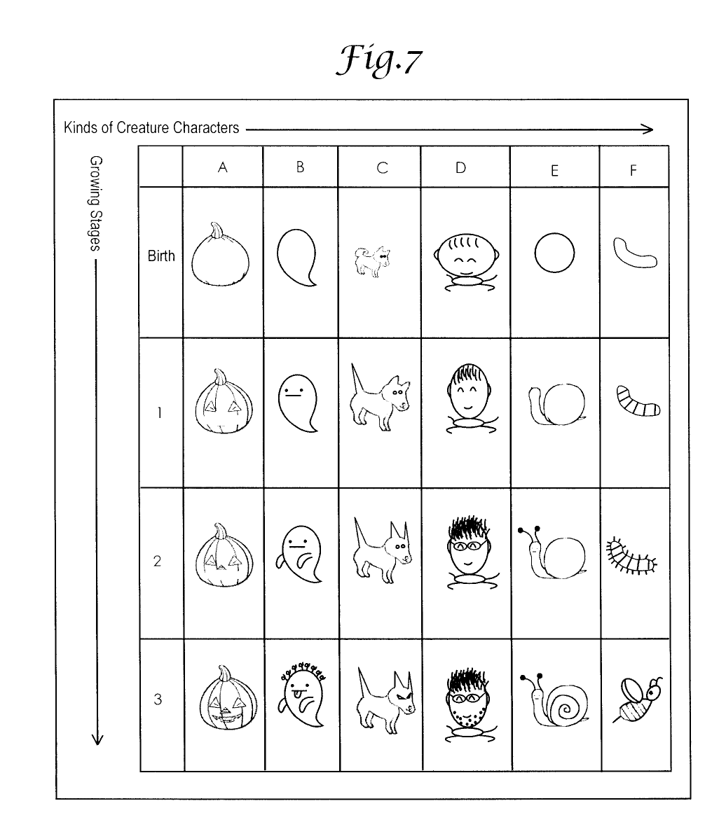

FIG. 5 is a block diagram showing a configuration of a main part of the control circuit mounted on the circuit substrate 11. The main part of the control circuit 11 shown in FIG. 5 includes character-to-be-fostered selecting means 21, display control means 23, image storing means 25, first temperature-condition determination means 27, timer means 29, second temperature-condition determination means 31, and image restoration command generating means 33. The image storing means 25 stores an image representing an unknown state where no virtual creature character is born yet, as shown in FIG. 6A, images of a plurality of kinds of virtual creature characters A to F each representing a newborn appearance thereof, as shown in FIG. 6B, and images or image units of the plurality of kinds of virtual creature characters corresponding to respective growing stages thereof from birth to maturity, as shown in FIG. 7. In FIGS. 6 and 7, creatures A to F are shown as examples of six kinds of virtual creature characters. A virtual creature character is not limited to the examples shown in FIGS. 6 and 7, and any kind of creatures may be applied as long as they can be born and grow up. For example, a virus, a bacterium, a microorganism, a monster, or even a fictitious creature may be applied. The term “growth” or “fostering” used herein may represent a change in the appearance of a character as with the growth of a human being from an infant to an adult, but may represent a process in which a character is born imperfectly with some parts of the body thereof missing, and then the missing parts are successively added to the body to form the perfect virtual creature character, as shown in FIG. 7. The term “image” used herein means both of a static image and an animated image.

The character-to-be-fostered selecting means 21 of FIG. 5 outputs to the display control means 23 a selection command to select one or more virtual creature characters among the plurality of kinds of virtual creature characters based on an output from the temperature sensor 13. The display control means 23, in response to the selection command, reads out an initial image (from among the images of FIG. 6B, or the images in the “birth” row in FIG. 7) of the selected virtual creature character from the image storing means 25, and displays it on the image display portion 4.

This example assumes that one virtual creature character is selected. When selecting a plurality of virtual creature characters, virtual creature characters of the same kind or different kinds may be selected.

In this example, as shown in FIG. 6A, before the character-to-be-fostered selecting means 21 outputs a selection command, a hazy cloud-like object, which represents an unknown state where no virtual creature character is born yet, is displayed on the display screen 10 of the display device 9. First, the character-to-be-fostered selecting means 21 calculates an accumulated time length during which the temperature of the casing 1 detected by the temperature sensor 13 is equal to or higher than a predetermined temperature above ordinary temperature. Then, a virtual creature character to be fostered is determined among the creatures A to F, or the plurality of kinds of virtual creature characters, in accordance with the accumulated time length, and one of the initial images (images of FIG. 6B or images of the “birth” row in FIG. 7) of the virtual creature character, which represents a newborn appearance thereof is displayed on the display screen 10. More specifically, the predetermined temperature above ordinary temperature is defined based on the temperature of the casing 1 when the casing is warmed by the body temperature of a human being (specifically, around 30° C. to 37° C.). In this manner, the casing may be prevented from being affected by ambient air etc which may cause the displayed image to change. In addition, the user may feel that the behavior of warming is needed as with when warming a real egg because the user has to warm the casing 1 with the body temperature in order to give birth to a virtual creature character. Incidentally, in the present embodiment, although the predetermined temperature is set to 35° C. as will be explained in detail later, it is not limited to this temperature.

In the present embodiment, the accumulated time length at the time of birth, during which the temperature of the casing 1 is equal to or higher than the predetermined temperature above ordinary temperature, is a time period during which the temperature sensor 13 is continuously detecting a temperature which is equal to or higher than the predetermined temperature. Accordingly, if the warming behavior is given up on the way, it may happen that no virtual creature character should be born. Thus, the user may understand that it is important for the birth of a virtual creature character to continue the warming behavior for a given period just like it is necessary to warm an egg for a given period to give birth to a real creature from the egg, and may feel that the user is participating in the birth of the virtual creature character.

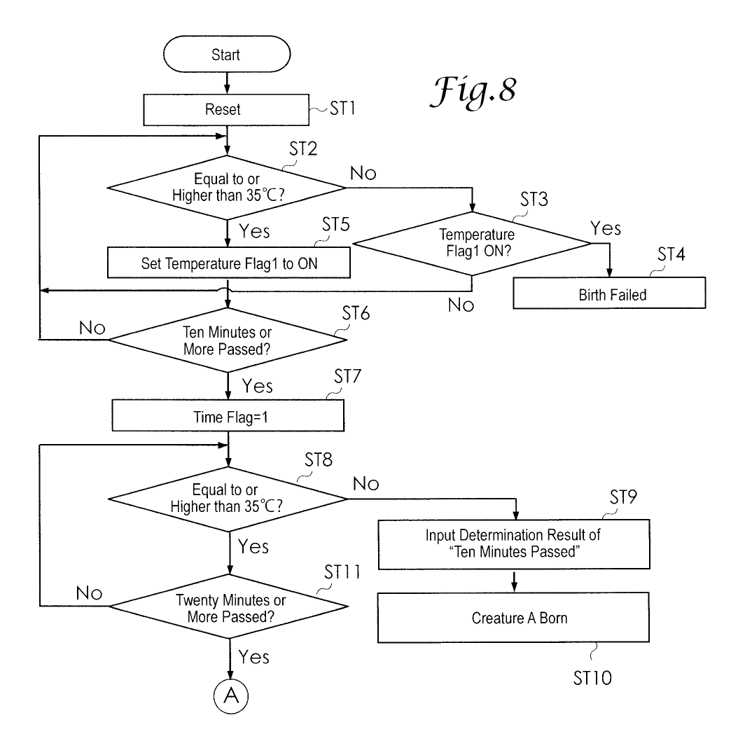

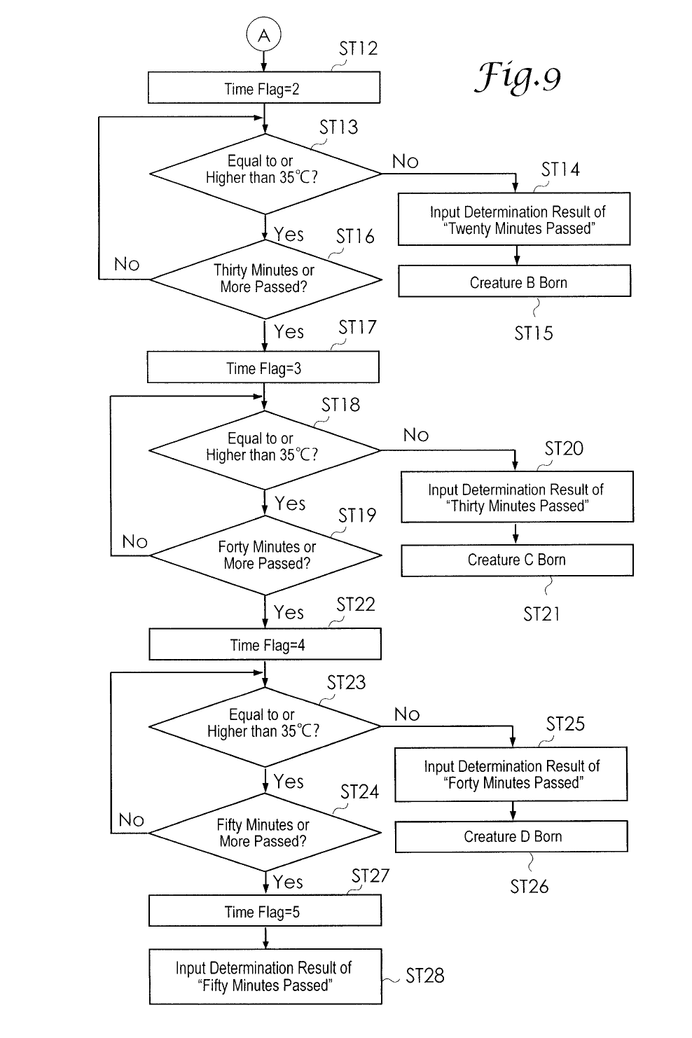

FIGS. 8 and 9 are flowcharts showing a programming algorithm applied in implementing character-to-be-fostered selecting means 21 using a microcomputer. The first half steps are shown in FIG. 8 and the latter half steps are shown in FIG. 9. In this example, one virtual creature character is selected among four kinds of virtual creature characters. The number of the selectable characters is arbitrary. As shown in FIG. 8, first, the program is reset in step ST1. In step ST2, it is determined whether or not the temperature of the casing 1 detected by the temperature sensor 13 is equal to or higher than 35° C. If the temperature is lower than 35° C., the process proceeds to step ST3 where it is determined whether or not temperature flag1 is ON. If temperature flag1 is not ON, the process returns to step ST2. If temperature flag1 is ON, it proceeds to step ST4 where birth has failed. Namely, as long as the temperature of the casing 1 is not equal to or higher than 35° C., it is always impossible to select any virtual creature character.

If it is detected in step ST2 that the temperature of the casing 1 is equal to or higher than 35° C., the process proceeds to step ST5 and temperature flag1 is set to ON. Then the process proceeds to step ST6 where it is determined whether or not ten minutes or more have passed since the warming behavior started. If ten minutes have not passed yet, the process returns to step ST2, and if ten minutes have passed, it proceeds to step ST7 where a time flag is set to “1”. Then the process proceeds to step ST8. In step ST8, it is determined whether or not the temperature of the casing 1 detected by the temperature sensor 13 is equal to or higher than 35° C. If the temperature is below 35° C., the process proceeds to step ST9 where a determination result that ten minutes have passed with the temperature being kept equal to or higher than 35° C. is inputted. Then in step ST10, the selection command to give birth to creature A, selected among a plurality of kinds of virtual creature characters, is outputted. If it is determined in step ST8 that the temperature is equal to or higher than 35° C., the process proceeds to step ST11 where it is determined whether or not twenty minutes have passed. If twenty minutes have not passed, the process returns to step ST8. If twenty minutes have passed, it proceeds to step ST12 of FIG. 9. In step ST12, the time flag is set to “2” and the process proceeds to step ST13. If the temperature is lower than 35° C. in step ST13, the process proceeds to step ST14 where a determination result that twenty minutes have passed with the temperature being kept equal to or higher than 35° C. is inputted. Then in step ST15, a selection command to give birth to creature B, selected among the plurality of kinds of virtual creature characters, is outputted.

If it is determined that the temperature is equal to or higher than 35° C. in step ST13, the process proceeds to step ST16 where it is determined whether or not thirty minutes have passed. If thirty minutes have not passed, the process returns to step ST13. If thirty minutes have passed, it proceeds to step ST17 where the time flag is set to “3”. Then the process proceeds to step ST18. As with the process as described above, a determination result that thirty minutes have passed with the temperature being kept equal to or higher than 35° C. is inputted in step ST20 and a selection command to give birth to creature C, selected among the virtual creature characters, is outputted in step ST21. If it is determined in step ST25, that a warmed condition of equal to or higher than 35° C. has been continued for forty minutes or more and less than fifty minutes, after going through steps ST19, ST22, and ST23, a determination result that forty minutes have passed with the temperature being kept equal to or higher than 35° C. is inputted. Then in step ST26, a selection command to give birth to creature D, selected among the virtual creature characters, is outputted. In this example, if it is detected through steps ST24, ST27, and ST28 that a temperature equal to or higher than 35° C. has been continued for fifty minutes or more, the process proceeds to a subsequent routine. What is processed in the subsequent routine is arbitrary. For example, it may be indicated that warming is excessive and the user may be encouraged to make another challenge, or a selection command may be outputted to select creature D as a virtual creature character whenever the warmed condition of equal to or higher than 35° C. has been continued for fifty minutes or more. If the one or more virtual creature characters to be fostered are determined in this manner, the user may feel that it is necessary for a birth of the virtual creature character to keep warming for a given time period as with when a bird warms an egg to let a chick be hatched therefrom. In addition, according to the present invention, since different virtual creature characters are born depending on how to warm (namely, the accumulated time length during which the casing is being warmed), the user may experience fostering of an unexpected virtual creature character by contriving ways of warming.

In the above-mentioned program, although a selection command to select a kind of virtual creature character to be born is outputted in accordance with the accumulated time length during which the temperature of the casing 1 is continuously equal to or higher than the predetermined temperature of 35° C., the accumulated time length may be a summation of time periods during which the temperature sensor 13 is detecting a temperature which is equal to or higher than the predetermined temperature. With such summation, even when the user who is not familiar with how to warm gives up warming on the way, the user may still give birth to a new or unexpected virtual creature character.

Referring back to FIG. 5, when the character-to-be-fostered selecting means 21 outputs a selection command to display one or more virtual creature characters selected among the plurality of kinds of virtual creature characters, the display control means 23 reads out an initial image which represents a newborn stage of the selected virtual creature character from the image storing means 25 in response to the command, and displays the image on the image display portion 4.

After the virtual creature character to be fostered has been determined, a growing image of the virtual creature character is displayed by operation of the display control means 23. In the present embodiment, after the initial image which represents a newborn stage of the virtual creature character has been displayed on the image display portion 4 in response to the selection command, an output from the temperature sensor 13 is used as one of growth element data for promoting the growth of the virtual creature character selected by the character-to-be-fostered selecting means 21. The display control means 23 determines a growing image of the virtual creature character to be displayed on the image display portion 4 based on the growth element data, and displays the growing image on the image display portion 4.

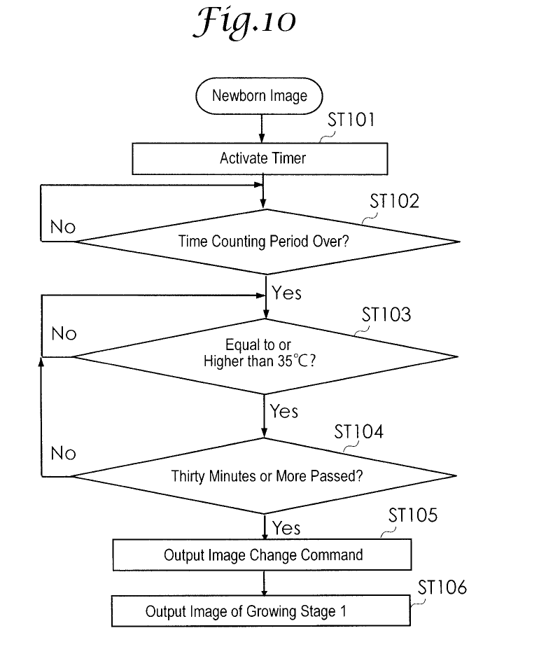

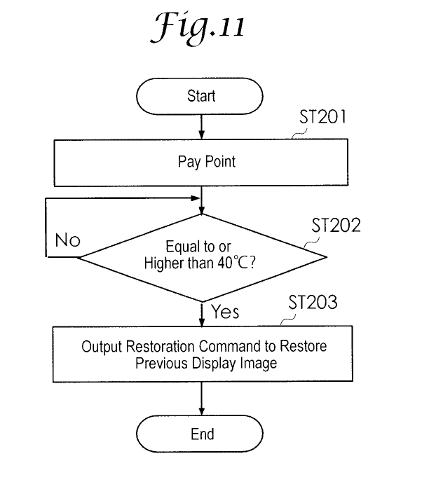

In the present embodiment, the timer means 29 and the first temperature-condition determination means 27 are provided in order for the display control means 23 to use an output from the temperature sensor 13 which detects a warmed condition, namely, the temperature of the casing 1 is in a fostering process. FIG. 10 is a flowchart schematically showing a basic operational algorithm in the fostering process. Referring to FIG. 10, in step ST101, the timer means 29 shown in FIG. 5 starts counting of a timer period after the display control means 23 has displayed the initial image of the virtual creature character (images selected from among FIG. 6B and those in the “birth” row in FIG. 7), which represents a newborn stage thereof, on the image display portion 4. If it is determined that the timer period counting has been completed in step ST102, the process proceeds to step ST103. Preferably, the timer period may be set comparatively long. For example, in the present embodiment, the timer period is set to 24 hours or one day. With the timer period setting, the user may feel that it takes a long time for virtual creature characters to grow up to a next stage, thereby raising the user's expectation for a new appearance of the grown-up character as with when raising a real creature.

After the timer means 29 has completed counting of a predetermined timer period, it is determined in steps ST103 and ST104 whether or not the temperature of the casing 1 has been continuously equal to or higher than 35° C. for thirty minutes or more. If the first temperature-condition determination means 27 determines in steps ST103 and ST104 that the temperature of the casing 1 has been continuously equal to or higher than 35° C. for thirty minutes or more, it outputs an image change command to the display control means 23 in step ST105. In step ST106, in response to the image change command, the display control means 23 reads out a corresponding growing image in the subsequent growing stage stored in the image storing means 25, replaces the previous image with this read-out image, and displays the image on the image display portion 4. Namely, the displayed image is changed from the initial image (newborn stage) to a growing image in the next stage (growing stage 1) as shown in the growing stages of FIG. 7. From this point on until the last image change command is outputted in step ST105, the process repeatedly returns to step ST101 whenever a new image of a higher growing stage is displayed on the image display portion 4. After the timer period counting has been completed, the casing is warmed again. The character is thereby growing up to a subsequent growing stage on condition that a temperature equal to or higher than 35° C. has been continued for thirty minutes or more, and a growing image of the character is accordingly changing step by step in the order of newborn stage, growing stage 1, growing stage 2, and growing stage 3 as shown in FIG. 7. When such basic algorithm is adopted, the user may understand that virtual creature character cannot grow up merely by a simple behavior of warming, and that passage of time is also very important for fostering. Accordingly, the user may enjoy leisurely fostering by spending the time.

In the above-mentioned embodiment, although the predetermined temperature for the first temperature-condition determination means 27 is set to 35° C. or more, the temperature predetermined by the temperature-condition determination means 27 is not limited to this setting. It is preferred that the predetermined temperature is higher than ordinary temperature and is defined based on the temperature of the casing 1 when the casing is warmed by the body temperature of a human being (specifically, around 30° C. to 37° C.). When the first temperature-condition determination means 27 is set up in this manner, a displayed image may be prevented from being affected by ambient air etc. winch may cause the displayed image to change. In addition, the user may understand that physical contact is important for healthily fostering a creature character as with when raising a real living creature because it is necessary to warm the casing 1 with the user's body temperature.

In the course of fostering, the user may sometimes want to return the image display from the current one to a previous growing stage. Of course, the apparatus may be configured to restore or return a display image by means of switch operation. However, if warming behavior is defined as a necessary condition for changing the image display, it is not easy to return the image display to a previous one. As a result, the user may experience that fostering is always accompanied by difficulties, thereby refraining from easily changing the fostering policy. Since the user understands difficulty in the course of fostering as with when the user actually fosters a real living creature, the user may feel more identified with the virtual creature character that the user is fostering. To realize this, second temperature-condition determination means 31 and image restoration command generating means 33 are provided in connection with the display control means 23, as shown in FIG. 5. As for the second temperature-condition determination means 31, a temperature, which is higher than the predetermined temperature set up for the character-to-be-fostered selecting means 21 and first temperature-condition determination means 27, is set up as a preset temperature. Specifically, it is preferred that the preset temperature is in the range of 40° C. to 46° C. The second temperature-condition determination means 31 determines whether or not the temperature of the casing 1 has become a temperature which is higher than the predetermined temperature based on an output from the temperature sensor 13. When the second temperature-condition determination means 31 determines that the temperature of the casing 1 has become the temperature which is higher than the preset temperature, the image restoration command generating means 33 outputs to the display control means 23 an image restoration command to return the display image from a current display image to a previous one. The display control means 23 reads out a previous image data or corresponding growing image in the previous stage from the image storing means 25 in response to the image restoration command and replaces the display image. As described above, since the preset temperature which is higher than the usual predetermined temperature is used in the second temperature-condition determination means 31, warming (temperature) required for usual fostering is definitely distinguishable from warming (temperature) required for returning the display image to a previous one. As a result, malfunction may be prevented from occurring, and the user may experience that fostering is accompanied by difficulties. Thus, the user may feel that the user is really involved in the fostering.

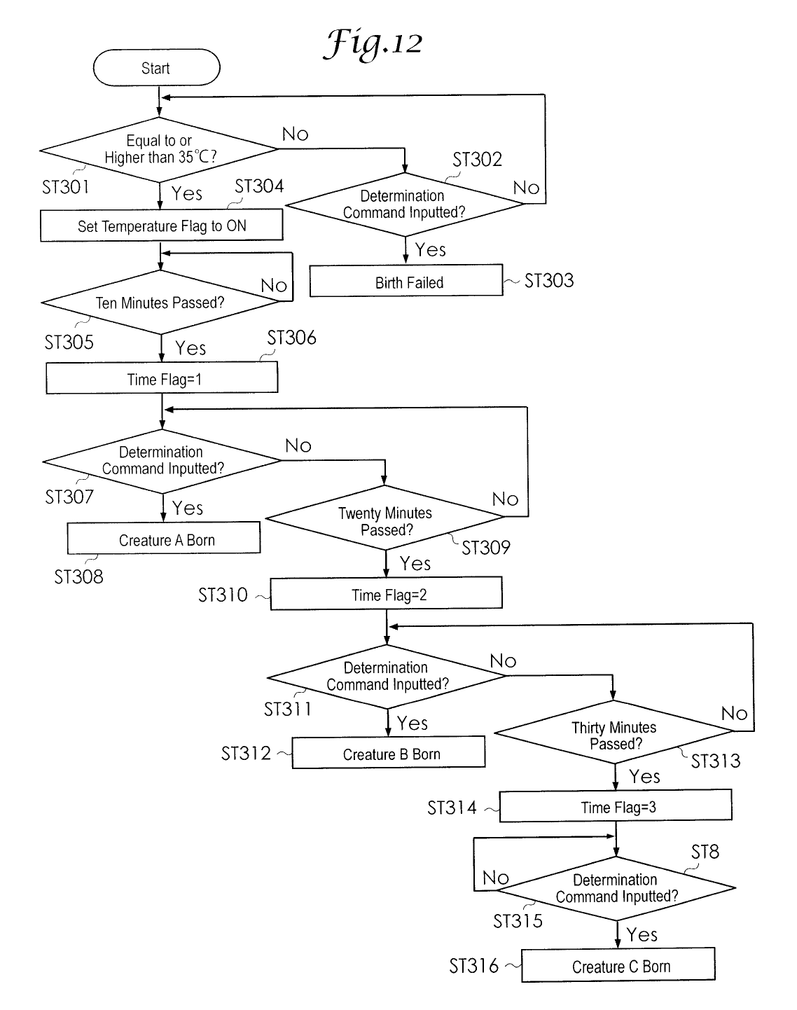

FIG. 11 is a flowchart showing an example algorithm when the second temperature-condition determination means 31 is used. In this example, payment of a point is required in step ST201. Namely, to return the display image from a current one to a previous one, it is required to pay a given point from among points the user have collected in some way or owned from the beginning. After a given point has been paid in step ST201, it is determined whether or not the temperature of the casing 1 has become the preset temperature 40° C. If the temperature has not become 40° C., the process returns to step ST202. If the temperature has become 40° C., the process proceeds to step ST203 where an image restoration command is outputted to read out an image of a previous growing stage.

According to the above-mentioned embodiment, determination of a virtual creature character to be fostered is made among a plurality of kinds of virtual creature characters, provided that the temperature sensor 13 is continuously detecting the temperature. However, if the user is a small child, it may happen that the user does not continuously warm the casing 1.

In another embodiment of the present invention, even if the temperature sensor is not continuously detecting the temperature, determination of a virtual creature character to be fostered may be made in a simple manner, for example, by inputting a determination command by means of switch operation, provided that the casing 1 was warmed and the temperature sensor has detected a given temperature even once.

FIG. 12 is a flowchart showing an example algorithm to be applied when determining one virtual creature character to be fostered among a plurality of kinds of virtual creature characters through a warming behavior and an input operation of a determination command as described above. More specifically, one or more virtual creature characters to be fostered are determined among the plurality kinds of virtual creature characters in accordance with an accumulated time length after the temperature of the casing 1 detected by the temperature sensor 13 has become the predetermined temperature or 35° C. till the determination command is inputted, and an initial image representing a newborn stage of the one or more virtual creature characters is displayed. To execute the algorithm, the character-to-be-fostered selecting means 21 is configured to include a determination command input means for inputting a determination command. In the present embodiment, although not shown in FIG. 5, any one of the switches 3a to 3c appearing in FIG. 1 is used as the determination command input means. During a time period after the temperature sensor 13 has detected the predetermined temperature till the determination command is inputted, a hazy cloud-like object, which represents an unknown state where no virtual creature character is born yet, is displayed on the display screen 10 of the display device 9 as shown in FIG. 6A. Then in step ST301, it is determined whether or not the temperature of the casing 1 detected by the temperature sensor 13 has become a temperature which is equal to or higher than the predetermined temperature 35° C. If the determination command is inputted before the temperature of casing 1 becomes the predetermined temperature 35° C., the process goes through steps ST302 and ST303, and birth of virtual creature fails. If the temperature detected by the temperature sensor has become 35° C. in step ST301, a temperature flag is set to ON in step ST304. It is determined in step ST305 whether or not ten minutes have passed since it was detected in step ST301 that the temperature had become 35° C. If it is determined that ten minutes have passed, the time flag is set to “1” in step ST306. Then, if a determination command is inputted before it is counted in step ST309 whether or not twenty minutes have passed, the process goes through step ST307 to step ST308 where creature A is born, selected among the virtual creature characters. If it is counted in step ST309 that twenty minutes have passed, the time flag is set to “2” in step ST310. If a determination command is inputted after twenty minutes have passed before thirty minutes have passed, the process goes through step ST311 to step ST312 where creature B is born, selected among the virtual creature characters. After it is counted in step ST313 that thirty minutes have passed, the time flag is set to “3” in step ST314. From this point on, if a determination command is inputted, the process goes through step ST315 to step ST316 where creature C is born, selected among the virtual creature characters. As mentioned above, in the algorithm of FIG. 12, it is determined whether or not the determination command is inputted in steps ST302, ST307, ST311, and ST315. In steps ST305, ST309, and ST313, it is detected how much time has passed since the given temperature was detected in step ST301. In this manner, once a temperature of the casing 1 equal to or higher than the predetermined temperature has been detected and a given time has passed, one of the virtual creature characters may be born in accordance with an inputted determination command. Thus, the kind of character to be born is determined based on the timing of inputting a determination command, namely, the accumulated time length after it is detected that the temperature of the casing 1 has become the predetermined temperature. Thereby, it becomes possible to give birth to a virtual creature character even if it is difficult for a user to keep warming for a given period, or even if the warming behavior is not appropriate. Accordingly, just a little child can master the game apparatus.

According to the above-mentioned embodiment, although the predetermined temperature detected by the temperature sensor 13 is set to 35° C., it is not limited to this setting.

Although not shown, according to the present embodiment, the process also goes to the step where a birth failed if a determination command is inputted before ten minutes have not passed after the temperature has become 35° C. in step ST301. However, another kind of virtual creature character may be born in the meantime.

In the above-mentioned embodiment, although the casing 1 is oval like an egg in shape, it is not limited to this shape and any shape may be applied as long as it can be warmed by hands. In the above-mentioned embodiment, an image displayed on the image display portion can be seen through the view window 5 disposed in the casing 1. However, the present invention is applied not only to such configuration having an image display portion as mentioned above, and of course it may also be applied to a publicly known configuration of an image display portion of which a display screen is exposed on the surface of the casing and other configurations of image display portions.

In the above-mentioned embodiment, characters are grown based on a temperature and time length of warming as growth element data even after the character was born. However, the growth element data are not limited to this, and it is needless to say that any kind of growth element data may be used to foster the characters.

### INDUSTRIAL APPLICABILITY

According to the present invention, since it is necessary to give birth to a virtual creature character to warm the casing for a given time period, the user may feel that the user is really involved in the birth of the virtual creature character through the behavior of warming. In addition, since different virtual creature characters are born depending on how to warm (how long the casing is warmed), the user may experience fostering of an unexpected virtual creature character by contriving the way of warming, thereby increasing the user's interest.

1. A virtual creature character fostering apparatus comprising:
a temperature sensor disposed inside a casing to detect a temperature of the casing;
character-to-be-fostered selecting means which outputs a selection command to select one or more virtual creature characters to be fostered among a plurality of kinds of virtual creature characters, based on an output from the temperature sensor; and
display control means which displays on an image display portion an image of the one or more virtual creature characters selected by the character-to-be-fostered selecting means while the one or more virtual creature characters are growing up, wherein
the character-to-be-fostered selecting means which calculates an accumulated time length during which the temperature of the casing detected by the temperature sensor is equal to or higher than a predetermined temperature above ordinary temperature, and determines the one or more virtual creature characters to be fostered among the plurality of kinds of virtual creature characters in accordance with the accumulated time length; and
the display control means displays an initial image of the one or more virtual creature characters on the image display portion, based on the selection command.

2. The virtual creature character fostering apparatus according to claim 1, wherein the accumulated time length is a time period during which the temperature sensor is continuously detecting a temperature which is equal to or higher than the predetermined temperature.

3. The virtual creature character fostering apparatus according to claim 1, wherein the accumulated time length is a summation of time periods during which the temperature sensor is detecting a temperature which is equal to or higher than the predetermined temperature.

4. The virtual creature character fostering apparatus according to claim 1, wherein the image display portion includes a display device disposed inside the casing and a view window portion disposed in the casing to allow the display device inside the casing to be viewed therethrough.

5. The virtual creature character fostering apparatus according to claim 1, wherein the temperature sensor is installed inside the casing with a sensor portion thereof being in contact with an inner wall surface of the casing.

6. A virtual creature character fostering apparatus comprising:
a casing onto which an image display portion is fixed;
a temperature sensor disposed inside the casing to detect a temperature of the casing;
character-to-be-fostered selecting means which outputs a selection command to select one or more virtual creature characters to be fostered among a plurality of kinds of virtual creature characters, based on an output from the temperature sensor; and
display control means which displays an initial image of the one or more virtual creature characters on the image display portion, based on the selection command, uses an output from the temperature sensor as one of growth element data for promoting the growth of the one or more virtual creature characters selected by the character-to-be-fostered selecting means, determines a growing image of the one or more virtual creature characters to be displayed on the image display portion based on the growth element data, and displays the growing image on the image display portion, wherein
the character-to-be-fostered selecting means calculates an accumulated time length during which the temperature of the casing detected by the temperature sensor is above ordinary temperature and is equal to or higher than a predetermined temperature defined based on the temperature of the casing when the casing is warmed by the body temperature of a human being, and determines the one or more virtual creature characters to be fostered among the plurality of kinds of virtual creature characters in accordance with the accumulated time length; and
the display control means displays the initial image of the one or more virtual creature characters on the image display portion, based on the selection command.

7. The virtual creature character fostering apparatus according to claim 6, wherein the accumulated time length is a time period during which the temperature sensor is continuously detecting a temperature which is equal to or higher than the predetermined temperature.

8. The virtual creature character fostering apparatus according to claim 6, wherein the accumulated time length is a summation of time periods during which the temperature sensor is detecting a temperature which is equal to or higher than the predetermined temperature.

9. The virtual creature character fostering apparatus according to claim 6, wherein the image display portion includes a display device disposed inside the casing and a view window portion disposed in the casing to allow the display device inside the casing to be viewed therethrough.

10. The virtual creature character fostering apparatus according to claim 6, wherein the temperature sensor is installed inside the casing with a sensor portion thereof being in contact with an inner wall surface of the casing.

11. A virtual creature character fostering apparatus comprising:
a temperature sensor disposed inside a casing to detect a temperature of the casing;
character-to-be-fostered selecting means which outputs a selection command to select one or more virtual creature characters to be fostered among a plurality of kinds of virtual creature characters, based on an output from the temperature sensor; and
display control means which displays on an image display portion an image of the one or more virtual creature characters selected by the character-to-be-fostered selecting means while the one or more virtual creature characters are growing up, wherein
the character-to-be-fostered selecting means includes a determination command input means which inputs a determination command, and determines the one or more virtual creature characters to be fostered among the plurality kinds of virtual creature characters in accordance with an accumulated time length after the temperature of the casing detected by the temperature sensor has become a predetermined temperature till the determination command is input; and
the display control means displays an initial image of the one or more virtual creature characters on the image display portion, based on the selection command.

12. The virtual creature character fostering apparatus according to claim 11, wherein the image display portion includes a display device disposed inside the casing and a view window portion disposed in the casing to allow the display device inside the casing to be viewed therethrough.

13. The virtual creature character fostering apparatus according to claim 11, wherein the temperature sensor is installed inside the casing with a sensor portion thereof being in contact with an inner wall surface of the casing.
